(19) United States
(12) Patent Application Publication
(10) Pub. No.: US 2010/0151901 A1
(43) Pub. Date: Jun. 17, 2010

(54) Mobile Shopper Wizard

(75) Inventors: Barbara Roden, Atlanta, GA (US); Mariana McGuire, Atlanta, GA (US)

Correspondence Address: AT&T Legal Department - Moazzam;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/335,463

(22) Filed: Dec. 15, 2008

(51) Int. Cl. H04M 1/00; G06K 7/01; G06K 7/10

(52) U.S. Cl. 455/556.1; 235/462.13; 235/462.41

(57) ABSTRACT

Devices and methods are disclosed which relate to taking a picture of a product barcode with a mobile telephone and retrieving an aggregate of relevant information concerning that product. When a consumer walks into a store and sees a product, the consumer may take a picture of the product's barcode using a camera on a mobile telephone. Once the picture is taken, software onboard the mobile telephone recognizes it as a single product and a search begins for information concerning that product. The search is performed by a server located somewhere on the same mobile network as the consumer. The server accesses a plurality of databases, some of its own plus many others. The server searches for similar products, competing prices, local availability, etc. Once the information is retrieved from the databases, the server then filters the information according to location and any other constraints the consumer may have. The server then sends the aggregate of filtered information to the consumer's mobile telephone. The aggregate is sent to the mobile telephone in a mobile format so that the consumer can quickly and easily understand the information. A list of menu options is displayed on the screen of the mobile telephone for the consumer. From the list the consumer selects an option to display more detailed information about the products prices, availability, competing products, accessories, etc.

### BACKGROUND OF THE INVENTION

1. Field of the Invention

The present invention relates to consumer information. More specifically, the present invention relates to consumer information delivered to a mobile telephone.

2. Background of the Invention

Cellular telephones are tremendously popular. It is estimated that at the end of 2007 the total worldwide subscriber rate reached 3.3 billion. Close to 80% of the world's population enjoys mobile telephone coverage, a figure that will only increase. As cellular telephones gain popularity, their functionality has increased also. Standard service includes voice calling, caller ID, call waiting, and voice mail. Service providers also offer text messaging, push mail, navigation, and even a high-speed internet connection directly to your telephone. Cellular phones frequently have cameras, with the resolution capabilities increasing with each new model. These cameras allow users to take pictures and videos.

Nearly all stores keep close track of their inventory. Most larger stores keep this electronically and often online. This often is done through the scanning of the bar codes of items. A user can check sites such as www.circuitcity.com to see if a product is in stock in their local store as well as check its price, etc.

Barcodes are frequently used to identify products, whether it be for checkout at a store, inventory checks, etc. A barcode is an optical machine-readable representation of data. Originally, barcodes represented data in the widths (lines) and the spacings of parallel lines. These generally are referred to as linear or one-dimensional bar codes. Barcodes now also come in patterns of squares, dots, hexagons and other geometric patterns within images. These are two-dimensional matrix codes. The patterns and spacing of the patterns constitute the data encoding scheme. Barcodes can be read by optical scanners called barcode readers or scanned from an image by special software. This allows data to be quickly captured.

There are many product information guides that exist on the internet today. Websites such as AMAZON.COM, BIZRATE.COM, PRICEGRABBER.COM, FROOGLE.COM, etc. Many of these websites contain product reviews, product comparisons, price guides, and local availability. Many of these websites contain mobile versions of the site as well. Mobile versions of websites are usually laid out to conform to a smaller screen with lower resolution. Browsing websites using mobile phones can be tedious. Even though many websites are corrected for lower resolution and less inputs, users still struggle to navigate a page with the limited controls available to them on most mobile telephones.

At the same time mobile communication service providers are able to locate any mobile telephone on the network. Some mobile telephones are equipped with Global Positioning Systems (GPS), which can determine the exact location of a mobile telephone. Other telephones use Assisted Global Positioning Systems (aGPS), which is not quite as accurate as GPS, but gives a very close estimate based on the time the signal takes to travel to nearby towers.

What is needed in the art is a system and a method giving a consumer the ability to take a picture of a product barcode with their mobile telephone and have a software program pull an aggregate of information from the internet or a database concerning the product. The aggregate of information needs to be filtered and presented to the user in a form suitable for mobile telephone capabilities.

### SUMMARY OF THE INVENTION

The present invention includes devices and methods for taking a picture of a product barcode with a mobile telephone and retrieving an aggregate of relevant information concerning that product. When a consumer walks into a store and sees a product, the consumer may take a picture of the product's barcode using a camera on a mobile telephone. Once the picture is taken, software onboard the mobile telephone recognizes it as a single product and a search begins for information concerning that product. The search is performed by a server located on the same mobile network as the consumer. The server accesses a plurality of databases, some of its own plus many others. The server searches for similar products, competing prices, local availability, etc. Once the information is retrieved from the databases, the server then filters the information according to location and any other constraints the consumer may have. The server then sends the aggregate of filtered information to the consumer's mobile telephone. The aggregate is sent to the mobile telephone in a mobile format so that the consumer can quickly and easily understand the information. A list of menu options is displayed on the screen of the mobile telephone for the consumer. From the list the consumer selects an option to display more detailed information about the products prices, availability, competing products, accessories, etc. The consumer may find a comparable product, at a lower price, and right down the street.

In one embodiment, the present invention is a mobile communications device, comprising a housing, a digital camera coupled to the housing, a memory unit within the housing in communication with the digital camera, a processor within the housing and in communication with the memory unit, a display coupled to the housing and in communication with the memory, and a transceiver module within the housing and in communication with the memory. A picture of a product barcode is captured with the digital camera and an aggregate of information about the product is received in a mobile format.

In another embodiment, the present invention is a system for informing consumers of relevant product information on a mobile telephone, comprising a mobile communications network, a consumer server in communication with the mobile communications network, a consumer logic onboard the consumer server for retrieving and filtering a plurality of product information into an aggregate of relevant product information, and a plurality of databases in communication with the consumer server. The consumer server receives a product barcode from a mobile telephone and retrieves from the plurality of databases an aggregate of relevant product information and displays the aggregate on the consumer's mobile telephone.

In yet another embodiment, the present invention is a method of providing relevant product information to a consumer having a mobile telephone capable of taking a picture of a product barcode, comprising interpreting the picture of a product barcode retrieving a plurality of product information from a plurality of databases, filtering the plurality of product information into an aggregate of relevant product information, and displaying the aggregate of relevant product information on a mobile telephone.

In a further embodiment, the present invention is a software program stored on a computer readable medium that provides relevant product information to a consumer having a mobile telephone capable of taking a picture of a product barcode, comprising a first code segment for interpreting the picture of a product barcode, a second code segment for retrieving a plurality of product information from a plurality of databases, a third code segment for filtering the plurality of product information into an aggregate of relevant product information, and a fourth code segment for displaying the aggregate of relevant product information on a mobile telephone.

### BRIEF DESCRIPTION OF THE DRAWINGS

FIGS. 1A and 1B show front and rear views of a mobile telephone, according to an exemplary embodiment of the present invention.

FIG. 2 shows a top level view of a mobile network, according to an exemplary embodiment of the present invention.

FIG. 3 shows a mobile telephone taking a picture of a product barcode, according to an exemplary embodiment of the present invention.

FIG. 4 shows a flow diagram of a method of providing relevant product information to a consumer, according to an exemplary embodiment of the present invention.

FIG. 5 shows a screenshot of the menu system of an aggregate of relevant product information, according to an exemplary embodiment of the present invention.

### DETAILED DESCRIPTION OF THE INVENTION

The present invention includes devices and methods for taking a picture of a product barcode with a mobile telephone and retrieving an aggregate of relevant information concerning that product. When a consumer walks into a store and sees a product, the consumer may take a picture of the product's barcode using a camera on a mobile telephone. Once the picture is taken, software onboard the mobile telephone recognizes it as a single product and a search begins for information concerning that product. The search is performed by a server located on the same mobile network as the consumer. The server accesses a plurality of databases, some of its own plus many others. The server searches for similar products, competing prices, local availability, etc. Once the information is retrieved from the databases, the server then filters the information according to location and any other constraints the consumer may have. The server then sends the aggregate of filtered information to the consumer's mobile telephone. The aggregate is sent to the mobile telephone in a mobile format so that the consumer can quickly and easily understand the information. A list of menu options is displayed on the screen of the mobile telephone for the consumer. From the list the consumer selects an option to display more detailed information about the products prices, availability, competing products, accessories, etc.

A “network operator/service provider”, as used in this disclosure, is a telephone company that provides services for mobile phone subscribers. Examples of network operators include AT&T, VERIZON, T-MOBILE, SPRINT, etc.

A “user”, as used in this disclosure, refers to a person or device that utilizes the mobile telephone presented in this disclosure.

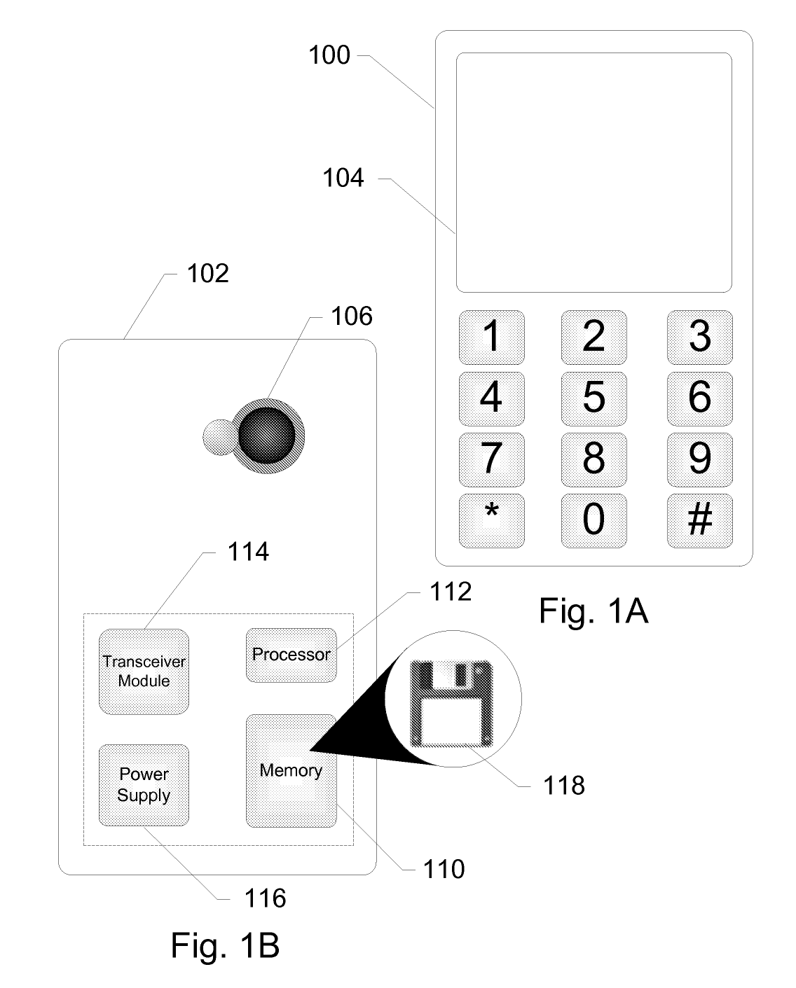

FIGS. 1A and 1B show a cellular telephone 100, according to an exemplary embodiment of the present invention. In this embodiment, mobile telephone 100 comprises a housing 102, a display 104, a digital camera 106, a memory 110, a processor 112, a transceiver module 114, a power supply 116, and optical recognition logic 118. Housing 102 holds each of the components of mobile telephone 100. Housing is generally comprised of a sturdy material such as plastic or metal to protect these components and keep them in place. Display 104 is located on the outside of housing 102 and allows a consumer to view numbers, select options, play games, see pictures, etc. Display 104 generally comprises a liquid crystal display (LCD). In alternative embodiments, such as flip telephones, the display is only shown when the telephone is “flipped open”. Digital camera 106 is located within housing 102, with the lens of digital camera 106 on the outer surface of housing 102. Digital camera 106 allows a consumer to take pictures which are stored on mobile telephone 100. Digital camera 106 is used to take pictures, such as barcodes, and send the pictures to memory unit 110. Memory unit 110 stores an operating system for mobile telephone 100. Memory unit 110 additionally stores photos, music, games, telephone settings, telephone numbers, etc. Onboard memory unit 110 stores an optical recognition logic 118. When a barcode picture is sent to memory unit 110, optical recognition logic 118 enhances and deblurrs the barcode picture. Optical recognition logic 118 then compares the enhanced photo with external product databases to determine the identity of the product using the barcode. Transceiver module 114 is utilized to communicate with networks. This communication may use a cellular Radio Frequency (RF) connection, BLUETOOTH connection, WiFi connection, etc. Optical recognition logic 118 communicates with external databases through transceiver module 114. Processor 112 runs the operating system of mobile telephone 100 as well as other features and programs. Power supply 116 provides power to each of the components of mobile telephone 100.

Alternately, some embodiments of the mobile telephone are equipped with a digital camera featuring a macro-lens. Many camera telephones are autofocus, yet have trouble focusing at close ranges. Since resolution is not a priority for most camera telephones a barcode picture needs to be taken closely. A macro-lens has the ability to focus on an object that is very close to the lens. Mobile telephones equipped with the macro-lens have the ability to take pictures and interpret products without the need for the deblurring and enhancing provided by the optical recognition logic. Another embodiment that purges the need for deblurring and enhancing is a mobile telephone with a high resolution camera. With a camera that is higher resolution, such as three megapixels, a picture of a barcode can be taken from a further distance and is still readable by the optical recognition logic without deblurring or enhancing. The ability of the high resolution camera to take pictures from a further distance also purges the need for a macro-lens. Actual distances necessary will vary depending on the exact quality of the camera and must consider other variables, beside resolution, such as lens quality, room lighting, color depth, etc. Certain embodiments of the mobile telephone do not contain the optical recognition logic, which is responsible for deblurring and enhancing the picture of a product barcode, because the network operator can supply the optical recognition logic.

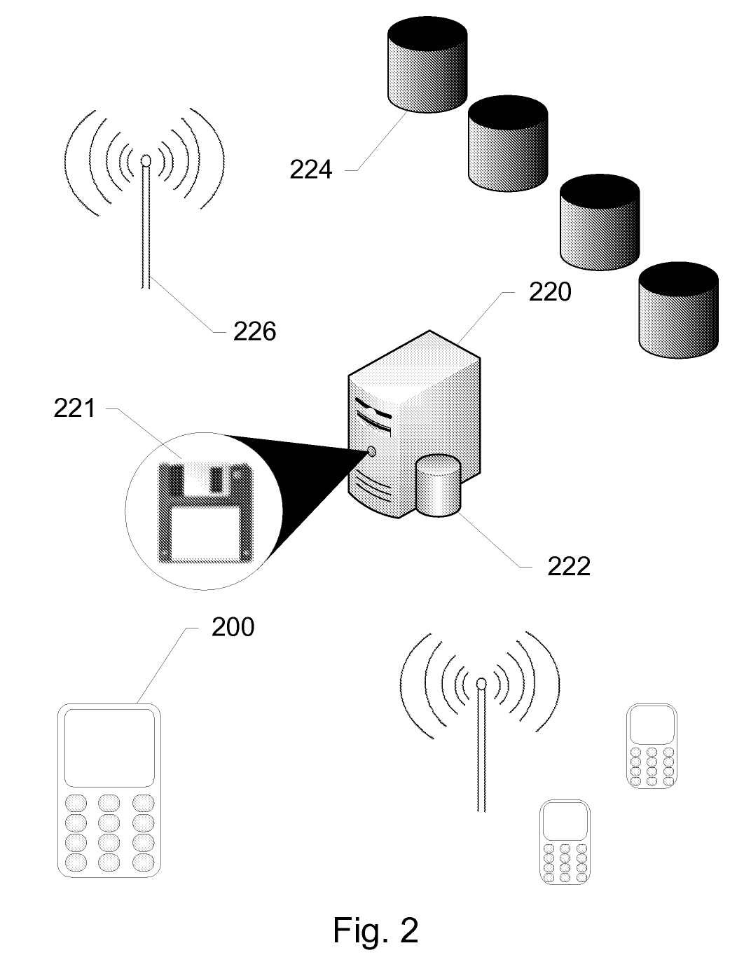

FIG. 2 shows a system for receiving product data, according to an exemplary embodiment of the present invention. In this embodiment, a mobile telephone 200 is in communication with a consumer server 220 through a mobile network 226. Consumer server 220 is in further communication with a network database 222 and third party databases 224. Consumer server 220 also contains a consumer logic 221. Mobile telephone 200 has the ability to take and send pictures. A consumer may take a picture of a barcode with mobile telephone 200. Mobile telephone 200 sends an enhanced and deblurred picture of the barcode to consumer server 220. This is accomplished by connecting with mobile network 226 and using the connection to send the picture to consumer server 220. Consumer server 220 with the use of consumer logic 221 compares the barcode picture with data in network database 222. Consumer logic 221 determines the identity of the product correlated to the barcode. With the identity of the product known, consumer server 220 communicates with third party databases 224 to gather product information. Product information includes product specifications, reviews, prices, locations of retailers, substitutes, accessories, etc. Third party databases 224 may include the databases of retailers, manufacturers, vendors, independents, etc. With the product information gathered, consumer logic 221 sorts through the information to determine which product information is relevant. The relevancy may be determined based upon restrictions determined by the consumer, temporal restrictions, location restrictions, etc. The relevant product information is sent back from consumer server 220 to mobile telephone 200 through mobile network 226.

In addition to the consumer logic, embodiments of the consumer server contain an optical recognition logic. In these embodiments the mobile telephone does not require its own optical recognition logic. The picture of the product barcode is sent in its original form, which may lack clarity. Once the picture of the product barcode is received by the consumer server, the optical recognition logic clears the picture of the product barcode so that the product can be identified.

In alternative embodiments of the present invention, the mobile telephone utilizes a picture recognition logic. A picture recognition logic allows a user to take a picture of a product. The picture recognition logic determines the make and model of the product from the picture. This may be accomplished using an external database, software loaded onto the mobile telephone, etc.

Further exemplary embodiments utilize a radio-frequency identification (RFID) scanner or a near field communications (NFC) scanner. These embodiments utilizing an RFID or NFC scanner allow the user to scan products which are identified with an RFID tag. NFC scanners also allow the user to communicate with other NFC devices, such as one including product and pricing information.

There are many databases which contain product information. If the network operator has an INTERNET connection then anything on the INTERNET can be used as a database. Manufacturer websites contain detailed specifications and consumer manuals while vendor and retailer websites contain detailed inventory and delivery information. There are additionally independent websites which give consumer reviews and ratings without actually selling anything themselves. The network operator also has its own database. This database is used to keep track of most of the information the other databases supply with some of the network operator's own information. In other embodiments of the system, the network operator contracts with other databases to ensure more accurate and complete product information.

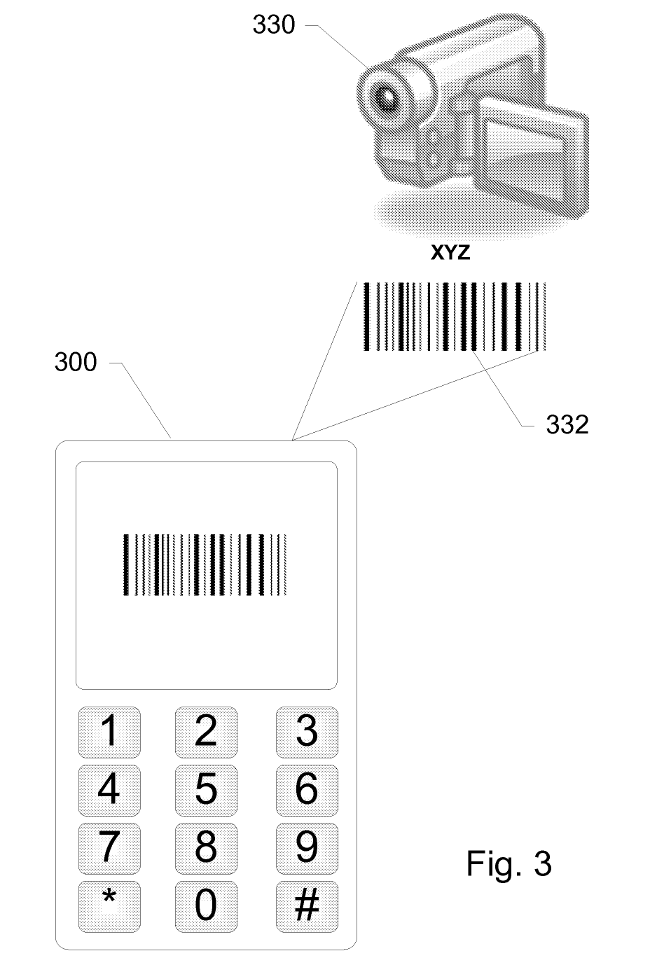

FIG. 3 shows the selection of a product, according to an exemplary embodiment of the present invention. In this embodiment, mobile telephone 300 captures a picture of a barcode 332 corresponding to video camera XYZ 330. When a consumer wishes to receive information concerning a product, the consumer uses mobile telephone 300 with an onboard digital camera to take a picture of barcode 332 corresponding to video camera XYZ 330. The picture of barcode 332 can be viewed on the display of mobile telephone 300. The picture of barcode 332 is sent to the memory unit of mobile telephone 300 where it is enhanced and deblurred by the optical recognition logic. The enhanced and deblurred picture is sent to a consumer server which sends back relevant product information. The picture shown on the display of mobile telephone 300 may be an enhanced and deblurred picture.

Barcodes can be found in any number of places. Most stores have product barcodes on a label that is separate from the product such as on the shelf. A product barcode can also be found on the box or tag of a product or even on the product itself. A consumer does not have to be in any store when the picture is taken. If the consumer is at a friend's house with a product having a barcode right on the product, a picture can be taken of the barcode. Useful product information is sent back to the mobile telephone with availability at stores near the consumer's friend.

The optical recognition logic relies on the deblurring and enhancing technology for many mobile telephones on the market. A barcode was originally meant to be read by an infrared laser. Enhancing and deblurring pictures of one-dimensional barcodes so that the barcode can be read has been the subject of research. There are many methods of making a picture of a barcode readable specifically when taken by a mobile telephone camera, such as the technology by REALEYES3D. This and other methods of deblurring and enhancing are readily recognizable by one skilled in the art.

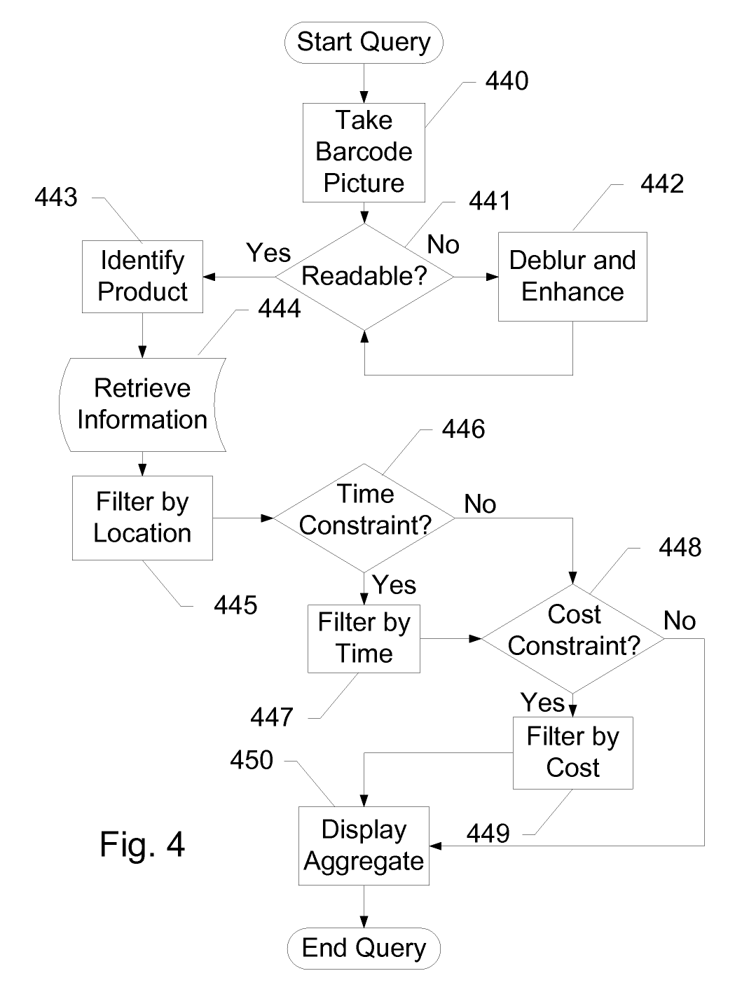

FIG. 4 shows a flowchart of a method of gaining product information, according to an exemplary embodiment of the present invention. In this embodiment, a consumer wishes to receive information concerning a product. The consumer first takes a picture of the barcode of the product 440 using the digital camera on the consumer's mobile telephone. Optical recognition logic onboard the mobile telephone determines whether the picture of the barcode is readable 441. If the barcode is not readable, the optical recognition logic deblurrs and enhances the picture 442. The optical recognition logic then again determines whether the barcode is now readable 441. Once the picture of the barcode is readable, the product is identified 443. The identification 443 is accomplished by sending the picture of the barcode to a consumer server with an onboard consumer logic. The consumer logic matches the picture of the barcode with product barcodes from a database. In an alternative embodiment, memory within the mobile phone contains product barcodes for comparison with the picture of the barcode. Once the product's identity is determined, the consumer server retrieves product information 444 from third party databases. These databases include those of retailers, manufacturers, vendors, independents, etc. This information may include information that is not relevant to the consumer and must be filtered. Consumer logic filters the product information by location 445. This may limit the results to certain geographical areas, types of stores, etc. The consumer logic then queries whether there are any temporal constraints 446 on the availability of the product. This may include constraints added by the consumer, such as stores open at the time, products that can be picked up at certain times, products that can be delivered by a certain time, etc. It may also filter out such information as sales that have expired or are not in effect during the times the product is needed. If a time constraint is present, the product results are filtered by that constraint 447. If there is no time constraint, or the results have been filtered, the consumer logic queries whether the consumer has selected any cost constraints 448. For example, the consumer may have found a product but wishes to know if there are any available for less than that amount. If the consumer has selected a cost constraint, the cost constraint is applied and filters the product results 449. If the consumer has not selected cost constraints, or after the constraints have been applied, the aggregated results remain. These results are sent back to the consumer's mobile telephone and the aggregate is displayed 450. With the aggregate displayed, the consumer is queried whether or not to purchase a product from the aggregated results 451. The consumer may purchase the product via payment mechanisms established with the service provider. For example, the service provider may bill the consumer on the consumer's next bill. Alternatively, the consumer may enter credit or debit card information, have a stored credit or debit card in a mobile wallet, etc. If the consumer purchases the product, the transaction is complete and the product is shipped to the consumer 452. The shipping may be based upon the address stored in the service provider's database or upon a separate entry by the consumer. If the consumer does not wish to purchase the product, the aggregate is stored for later viewing 453.

Other embodiments of the information gathering process include a network operator's own database for storing product information. However, there is a lot of time sensitive product information such as sales, availability, etc. Due to these factors, a network operator's own database maybe used for information that is not time sensitive. A database of product barcodes is stored on the network operator's database in certain embodiments while the consumer logic still accesses third-party databases for exact pricing and availability.

The filtering method is another area subject to variation in other embodiments of the information gathering process. Some consumers may want more constraints such as size, color, or edition. Other consumers may not even want their information localized. For example, a consumer looking for a small product that many places will ship for free may not care if the cheapest product is seven states away. Many filters and constraints are determined by the consumer in certain embodiments while the network operator can have its own adaptive filter. A network operator monitors a consumer's consumption patterns and modifies the filter as applied to that consumer accordingly. For instance if a consumer always selects an upgrade from the product associated with the barcode entered, then the filter eventually stops recommending lower-priced, lower-quality alternatives and spends more time bringing out higher-priced, higher-quality alternatives. Many other methods of filtering will be recognizable by one skilled in the art.

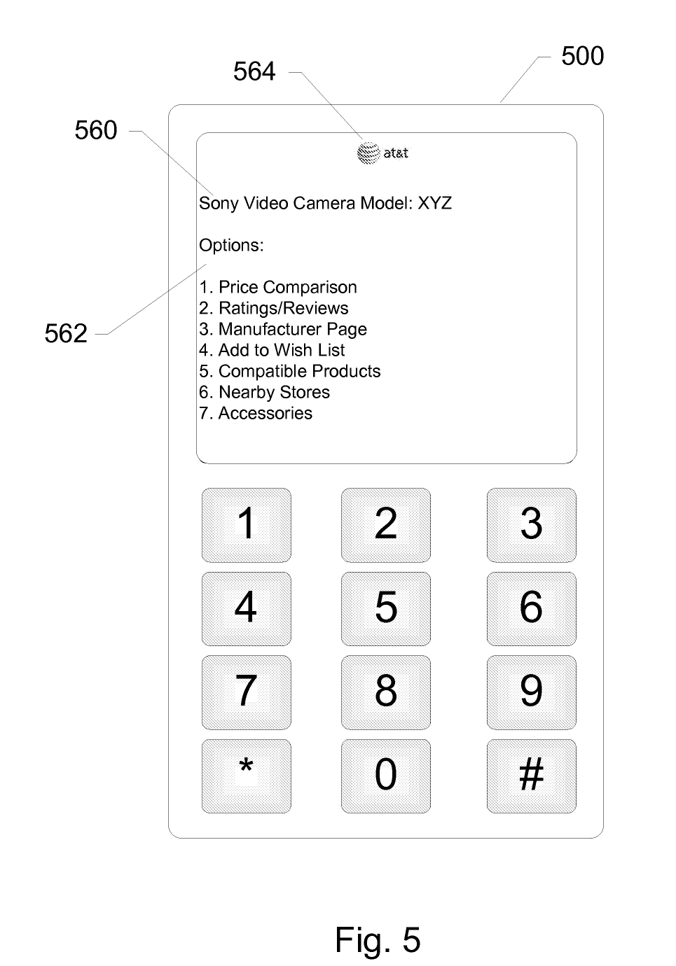

FIG. 5 shows a splash page with an options menu based upon a selected product, according to an exemplary embodiment of the present invention. In this embodiment, a consumer has already taken a picture of a product's barcode with a mobile telephone 500, the product has been identified, and relevant information has been received by mobile telephone 500. A product identity 560 is shown on the display of mobile telephone 500. This is the identity of the product correlating to the picture of the barcode. A service provider logo 564 may be on the splash page to inform the consumer of the connected network. Also on the display are options 562 which the consumer can select from. These options allow the consumer to find out information about the product as well as filter the information. In the present embodiment, options include a Price Comparison, Ratings and Reviews, Manufacturer Information, a Product Wish List, Compatible Products, Nearby Stores, and Accessories. Price comparison allows the consumer to see prices offered by other retailers, both in nearby geographic locations and on the internet. The consumer may filter results by a maximum price, minimum price, etc. Ratings and Reviews allow the consumer to see how others have rated the product. This may be ratings from a certain website or an aggregate of many websites and databases. The Manufacturer Page option allows the consumer to retrieve information directly from the manufacturer. This can include product specifications, warranties, etc. The option of adding the product to a Wish List allows the consumer to save the product to a database. The consumer can come back to the product later to see the options again. In further embodiments, the Wish List can be seen by other consumers who may purchase the product for the original consumer. Compatible Products allows the consumer to see products that are similar to the selected product. Compatible Products also shows other types of products that are compatible with the product. For example, the product may be compatible with certain other products which use a BLUETOOTH signal. Nearby stores shows the consumer the locations of stores selling the product in a nearby geographical area. The exact distance of results from the consumer's location can be predetermined by the consumer or can later be filtered. Accessories allows the consumer to view accessories for the product. For example, if the product is a portable music player, the accessories may include headphones, carrying cases, etc.

The hierarchy of information varies with different embodiments, but a mobile format is often desired due to the resolution and input restrictions of a mobile telephone. The menu system can use text labels and format the information into a single column format. Consumers enjoy different levels of bandwidth with their mobile telephones. Consumers may have their choice of whether or not to include pictures in the results or specify the size and quantity. Consumers with mobile telephones capable of higher bandwidths can have pictures download right along with the data while consumers with mobile telephones of lesser bandwidth capabilities can have text links to pictures so that the pictures are not loaded until consumer action. Other consumers have sophisticated Personal Digital Assistant (PDA) phones and Ultra Mini Personal Computer (UMPC) phones. These consumers can enjoy graphic intensive menu systems, if they elect.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A mobile communications device comprising:
a housing;
a digital camera coupled to the housing;
a memory unit within the housing in communication with the digital camera;
a processor within the housing and in communication with the memory unit;
a display coupled to the housing and in communication with the memory unit; and
a transceiver module within the housing and in communication with the memory unit;
wherein a picture of a product barcode is captured with the digital camera and an aggregate of relevant product information is received and shown on the display.

2. The device in claim 1, wherein the memory unit contains an optical recognition logic for interpreting the picture of a product barcode.

3. The device in claim 2, wherein the interpreting includes deblurring and enhancing the picture of a product barcode.

4. The device in claim 1, wherein the digital camera has a macro-lens.

5. The device in claim 1, wherein the transceiver module is capable of cellular RF transmission and reception.

6. The device in claim 1, wherein the transceiver module is capable of BLUETOOTH, WiFi, and infrared transmission and reception.

7. The device in claim 1, wherein the aggregate of relevant product information is shown in a mobile format on the display.

8. A system for informing consumers of relevant product information on a mobile telephone comprising:
a mobile communications network;
a consumer server in communication with the mobile communications network;
a consumer logic on the consumer server for retrieving and filtering a plurality of product information into an aggregate of relevant product information; and
a plurality of databases in communication with the consumer server;
wherein the consumer server receives a product barcode from a mobile telephone and retrieves from the plurality of databases an aggregate of relevant product information and displays the aggregate on the consumer's mobile telephone.

9. The system in claim 8, wherein the mobile communications network comprises a central server and a plurality of cellular towers.

10. The system in claim 8, wherein the aggregate of relevant product information comprises prices, locations, availability, substitutes, features, accessories, and reviews.

11. A method of providing relevant product information to a consumer having a mobile telephone capable of taking a picture of a product barcode comprising:
interpreting the picture of a product barcode;
retrieving a plurality of product information from a plurality of databases;
filtering the plurality of product information into an aggregate of relevant product information; and
displaying the aggregate of relevant product information on a mobile telephone.

12. The method in claim 11, wherein interpreting comprises deblurring and enhancing the picture of a product barcode.

13. The method in claim 11, wherein the plurality of databases comprises a network operator's databases and a plurality of third-party databases.

14. The method in claim 13, wherein the plurality of third-party databases includes databases from manufacturers, vendors, retailers, and independents.

15. The method in claim 11, wherein the filtering comprises removing information no longer relevant based on a temporal restriction.

16. The method in claim 11, wherein the filtering comprises removing information no longer relevant based on a location.

17. The method in claim 11, wherein the filtering comprises removing information no longer relevant based on a consumption pattern.

18. The method in claim 11, wherein the filtering comprises removing information subject to a custom restriction.

19. The method in claim 11, wherein the displaying is in a mobile format.

20. A software program stored on a computer readable medium that provides relevant product information to a consumer having a mobile telephone capable of taking a picture of a product barcode comprising:
a first code segment for interpreting the picture of a product barcode;
a second code segment for retrieving a plurality of product information from a plurality of databases;
a third code segment for filtering the plurality of product information into an aggregate of relevant product information; and
a fourth code segment for displaying the aggregate of relevant product information on a mobile telephone.
